(19) United States
(12) Patent Application Publication
(10) Pub. No.: US 2026/0249449 A1
(43) Pub. Date: Aug. 27, 2026

(54) TRAINED MODEL GENERATION DEVICE, CONTROL DEVICE, TRAINED MODEL GENERATION METHOD, AND TRAINED MODEL GENERATION PROGRAM

(71) Applicant: OMRON CORPORATION, Kyoto (JP)

(72) Inventors: Masato KOBAYASHI, Tokyo (JP); Jun YAMADA, Tokyo (JP); Masashi HAMAYA, Tokyo (JP); Kazutoshi TANAKA, Tokyo (JP)

(73) Assignee: OMRON Corporation, Kyoto (JP)

(21) Appl. No.: 19/489,738

(22) PCT Filed: Jun. 7, 2024
(86) PCT No.: PCT/JP2024/020908

§ 371 Date: Dec. 3, 2025

(30) Foreign Application Priority Data
Jun. 8, 2023 (JP) 2023-095038

(51) Int. Cl. B25J 9/16; B25J 9/00; B25J 9/04

(52) U.S. Cl. CPC B25J 9/161; B25J 9/0087; B25J 9/042; B25J 9/163; B25J 9/1682

(57) ABSTRACT

A trained-model generation device acquires training data including behavior data of a human for training. The trained-model generation device causes a generative adversarial network model including a generator and a discriminator to perform machine learning, based on the training data, to generate a trained generator that outputs behavior data of a control-target robot in response to input of behavior data representing behavior of the human as a target.

### TECHNICAL FIELD

The present disclosure relates to a trained-model generation device, a control device, a trained-model generation method, and a trained-model generation program.

### BACKGROUND ART

Conventionally, a technique for teaching behavior to a dual arm robot having two arms is known (see, for example, Rohan Chitnis, Shubham Tulsiani, Saurabh Gupta, Abhinav Gupta, “Intrinsic Motivation for Encouraging Synergistic Behavior”, ICLR 2020.). In this technique, the dual arm robot performs trial and error to train predetermined behavior.

Further, a technique is known in which, when teaching behavior to a robot having a plurality of arms, the behavior is taught by an instructor different for each of the plurality of arms (see, for example, Albert Tung, Josiah Wong, Ajay Mandlekar, Roberto Martin, Yuke Zhu, Li Fei-Fei, Silvio Savarese, “Learning Multi-Arm Manipulation Through Collaborative Teleoperation”, ICRA, 2021.). In this technique, such an instructor remotely operates the robot to teach the behavior.

### SUMMARY OF INVENTION

### Technical Problem

Meanwhile, when a human teaches behavior to a robot, it is also necessary to consider physical restrictions on the behavior of the robot. For example, in a case where the movable range of the robot is different from that of the human, the robot may fail to perform the behavior even if the behavior can be easily performed by the human. Further, for example, in a case where the robot has a plurality of movable parts like a dual arm robot, it is necessary to cause the plurality of movable parts to perform collaborative behavior. When a human teaches behavior to a robot, it is difficult to teach the behavior while causing such a plurality of movable parts to perform the collaborative behavior.

Therefore, there may be a problem that it is difficult for a human to teach behavior to a robot.

The present disclosure has been made in view of the above points, and an object of the present disclosure is to facilitate generating behavior data of a robot from behavior data of a human.

### Solution to Problem

In order to achieve the above object, a trained-model generation device according to the present disclosure includes a trained-model generation device including: a training-related acquisition unit configured to acquire training data including behavior data of a human for training; and training unit configured to cause a generative adversarial network model including a generator and a discriminator to perform machine learning, based on the training data acquired by the training-related acquisition unit, the training unit being configured to generate a trained generator that outputs behavior data of a control-target robot in response to input of behavior data representing behavior of the human as a target.

A trained-model generation method according to the disclosure includes a trained-model generation method to be performed by a computer, the trained-model generation method including: processing of acquiring training data including behavior data of a human for training; and processing of causing a generative adversarial network model including a generator and a discriminator to perform machine learning, based on the training data acquired by the acquiring, to generate a trained generator that outputs behavior data of a control-target robot in response to input of behavior data representing behavior of the human as a target.

A trained-model generation program according to the disclosure includes a trained-model generation program for causing a computer to perform processing including; acquiring training data including behavior data of a human for training; and causing a generative adversarial network model including a generator and a discriminator to perform machine learning, based on the training data acquired by the acquiring, to generate a trained generator that outputs behavior data of a control-target robot in response to input of behavior data representing behavior of the human as a target.

### Advantageous Effects of Invention

According to the trained-model generation device, the control device, the trained-model generation method, and the trained-model generation program of the present disclosure, the behavior data of the robot can be easily generated from the behavior data of the human.

### BRIEF DESCRIPTION OF DRAWINGS

FIG. 1 explanatorily illustrates the overview of the present embodiment.

FIG. 2 explanatorily illustrates the overview of the present embodiment.

FIG. 3 explanatorily illustrates the overview of a framework of the present embodiment.

FIG. 4 explanatorily illustrates a generative adversarial network model according to the present embodiment.

FIG. 5 is a block diagram illustrating the schematic configuration of a trained-model generation system of the present embodiment.

FIG. 6 is a block diagram illustrating the hardware configuration of a trained-model generation device according to the present embodiment.

FIG. 7 is a block diagram illustrating the schematic configuration of a control system of the present embodiment.

FIG. 8 is a block diagram illustrating the hardware configuration of a control device according to the present embodiment.

FIG. 9 is a flowchart illustrating the flow of trained-model generation processing in the present embodiment.

FIG. 10 is a flowchart illustrating the flow of the trained-model generation processing according to the present embodiment.

FIG. 11 is a flowchart illustrating the flow of control processing in the present embodiment.

FIG. 12 explanatorily illustrates the present example.

FIG. 13 illustrates the result of the present example.

### DESCRIPTION OF EMBODIMENTS

Hereinafter, an exemplary embodiment of the present disclosure will be described with reference to the drawings. In the present embodiment, a control system equipped with a control device according to the disclosure will be described as an example. In the drawings, the same or equivalent components and portions are denoted by the same reference signs. The dimensions and ratios of the drawings are exaggerated for convenience of description, and thus may be different from the actual ratios.

### Overview of Present Embodiment

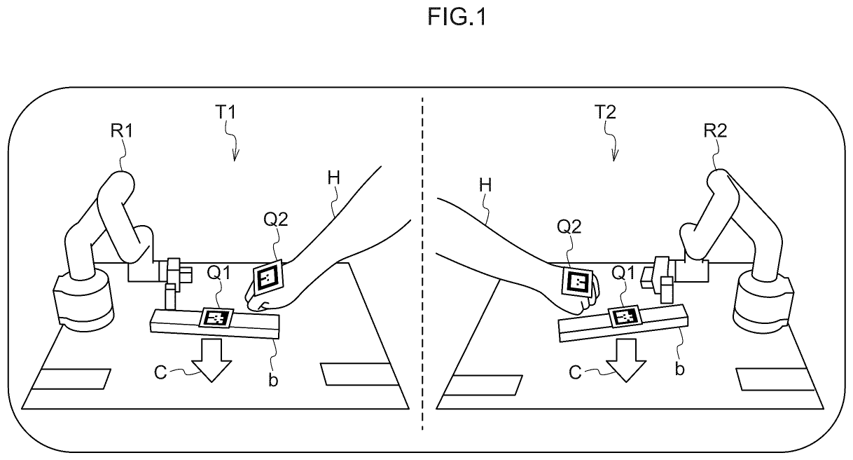

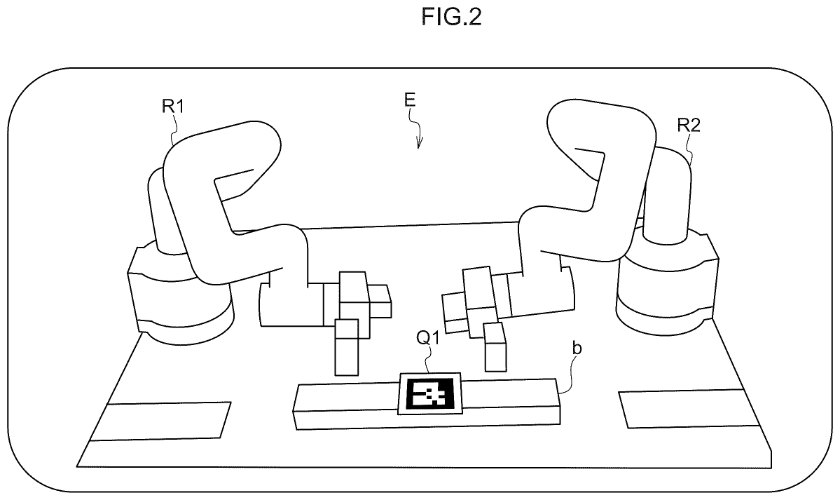

FIGS. 1 and 2 explanatorily illustrate the overview of the present embodiment. As illustrated in FIG. 1, in the present embodiment, behavior of a human H is taught to a dual arm robot including two arms R1 and R2. The example illustrated in FIG. 1 is an exemplary case where behavior for achieving a task of moving an object b in the direction of an arrow C is taught to the dual arm robot.

Specifically, as illustrated in T1 of FIG. 1, a demonstration for collaborative behavior by the first arm R1 of the dual arm robot and an arm of the human H is performed, and the positions of the two-dimensional barcodes Q1 and Q2 are captured by a camera (not illustrated). Further, as illustrated in T2 of FIG. 1, a demonstration for collaborative behavior by the second arm R2 of the dual arm robot and an arm of the human H is performed, and the positions of the two-dimensional barcodes Q1 and Q2 are captured by a camera (not illustrated).

The behavior data of such an arm of the human H and the object b in the demonstrations are generated on the basis of the positions of the two-dimensional barcodes Q1 and Q2. Further, the behavior data of the first arm R1 and the second arm R2 of the dual arm robot in the demonstrations is acquired from a control device (not illustrated) that controls the dual arm robot.

In the present embodiment, on the basis of the behavior data acquired in such a manner, behavior data to be taught to the first arm R1 and the second arm R2 of the dual arm robot is generated.

Then, as illustrated in E of FIG. 2, in the execution phase, the first arm R1 and the second arm R2 of the dual arm robot perform a task of moving the object b in the direction of the arrow C.

In this regard, for example, in order to teach behavior to the dual arm robot, a method is also conceivable in which the behavior is taught at one time to the first arm R1 and the second arm R2 that are dual arms, instead of teaching the behavior one by one as described above.

For example, a method is conceivable in which a human performs a task of moving the object b in the direction of the arrow C using both of the arms of the human, and behavior data at the time is acquired. However, in this case, the human may perform behavior that cannot be performed by the dual arm robot. For example, when the human performs a task of moving the object b in the direction of the arrow C, the human may move the object b at a speed exceeding the upper limit of the movement speed of the arms of the dual arm robot. Further, in a case where a task more complicated than the above task is to be performed, the human may perform behavior that does not consider the movable range of the arms of the dual arm robot.

Therefore, even if behavior data resulting from the use of the arms of the human is acquired, it is difficult to cause the dual arm robot to teach the behavior data as it is.

Furthermore, for example, a method is conceivable in which the human remotely operates the first arm R1 and the second arm R2 of the dual arm robot to perform a task of moving the object b in the direction of the arrow C and behavior data at that time is acquired. However, in this case, it is necessary to collaborate between the remote operation for the first arm R1 and the remote operation for the second arm R2.

In a case where a person who remotely operates the first arm R1 and a person who remotely operates the second arm R2 are different from each other, because task becomes more complicated, the collaboration is more difficult, thereby leading to difficulty in acquisition of appropriate behavior data. On the other hand, in a case where a human who remotely operates the first arm R1 and a human who remotely operates the second arm R2 are the same, it is necessary to make a device for achieving the remote operations complicated, and thus, the cost for preparing the device becomes enormous.

Thus, it is also difficult to acquire behavior data resulting from the remote operation of the first arm R1 and the second arm R2 of the dual arm robot by the human.

Therefore, in the present embodiment, as described above, a demonstration collaborative behavior by a human and a dual arm robot is performed to acquire the behavior data, so that behavior data to be taught to the dual arm robot is generated on the basis of the acquired behavior data.

Specifically, in the present embodiment, a known generative adversarial network model is used to generate behavior data of the dual arm robot from behavior data of the human. Hereinafter, a scene where the first arm R1 and the human H perform behavior as T1 in FIG. 1 is referred to as “Robot 1-Human”. As illustrated in T2 of FIG. 1, a scene where the second arm R2 and the human perform behavior is referred to as “Human-Robot 2”. Further, a scene where the human H and an arm of the dual arm robot simply perform behavior is referred to as “Human-Robot”. Furthermore, a scene where the first arm R1 and the second arm R2 of the dual arm robot perform behavior is referred to as “Robot 1-Robot 2” or “Robot-Robot”.

Hereinafter, the technique proposed in the present embodiment is also referred to as learning from demonstrations by human and robotic arms (LfD-HR).

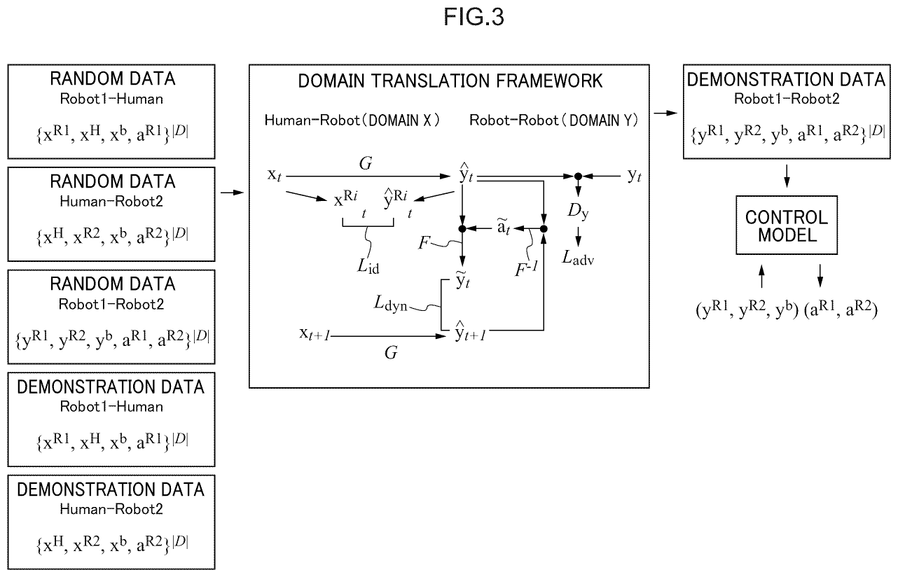

FIG. 3 explanatorily illustrates the overview of a framework of the present embodiment. Hereinafter, the framework of the present embodiment will be described with reference to FIG. 3.

### (A. Problem Formulation)

In the present embodiment, a problem is defined by a Markov Decision Process (S, A, P, ρ₀). Note that a state s∈S, an action a∈A, a transition function P(s′∈S|s, a), and po is an initial state. In the present embodiment, two domains are defined.

The domain X is a domain belonging to demonstration of a task by a human and a robot. The domain Y is a domain belonging to task behavior by the dual arm robot.

The behavior data belonging to the domain X includes the state x^{H} of an arm of the human H, the state x^{Ri} (i=1, 2) of the first arm R1 and the second arm R2 of the dual arm robot, the state x^{b} of the object b, and the action a^{Ri} of the first arm R1 and the second arm R2 of the dual arm robot.

The behavior data belonging to the domain Y includes the state y^{Ri} of the first arm R1 and the second arm R2 of the dual arm robot, the state y^{b} of the object b, and the action am of the first arm R1 and the second arm R2 of the dual arm robot.

In the present embodiment, the state x=(x^{H}, x^{Ri}, x^{b}) belonging to the domain X, the state y=(y^{R1}, y^{R2}, y^{b}) belonging to the domain Y, and the action (a^{R1}, a^{R2}) are defined. Further, in the present embodiment, Mₓ=(Sₓ, Aₓ, Pₓ, ρ₀ₓ) and M_{y}=(S_{y}, A_{y}, P_{y}, ρ_{0y}) are defined in the Markov decision process in the domain X and the domain Y Furthermore, in the present embodiment, as will be described later, the policy π:S_{y}→A_{y} is trained for the control model of the dual arm robot.

### (B. Data Collection)

First, in the present embodiment, as illustrated in FIG. 3, random data is collected. Specifically, as illustrated in FIG. 3, the random data {x^{R1}, x^{H}, x^{b}, a^{R1}}^{|D|} obtained in “Robot 1-Human” in the situation where the first arm R1 of the dual arm robot and the human H are caused to perform behavior is collected. Note that |D| represents the number of data sets.

Further, as illustrated in FIG. 3, the random data {x^{H}, x^{R2}, x^{b}, a^{R2}}^{|D|} obtained in “Human-Robot 2” in the situation where random behavior is performed by the second arm R2 of the dual arm robot and the human H is collected.

Furthermore, as illustrated in FIG. 3, the random data {y^{R1}, y^{R2}, y^{b}, a^{R1}, a^{R2}}^{|D|} of “Robot 1-Robot 2” is collected in the situation where random behavior is performed by the first arm R1 and the second arm R2 of the dual arm robot.

Next, as illustrated in FIG. 3, demonstration data is collected. The demonstration data is data obtained from collaborative behavior of the human H and the arm (the first arm R1 or the second arm R2) of the dual arm robot.

Specifically, as illustrated in FIG. 3, the demonstration data {x^{R1}, x^{H}, x^{b} a^{R1}}^{|D|} obtained in “Robot 1-Human” in the situation where collaborative behavior is performed by the first arm R1 of the dual arm robot and the human H is collected.

Further, as illustrated in FIG. 3, the demonstration data {x^{H}, x^{R2}, x^{b}, a^{R2}}^{|D|} obtained in “Human-Robot 2” in the situation where collaborative behavior is performed by the human H and the second arm R2 of the dual arm robot is collected.

### (C. Forward Dynamics Model and Inverse Dynamics Model)

In the present embodiment, a forward dynamics model F and an inverse dynamics model F⁻¹ relating to an arm of the dual arm robot are defined.

The forward dynamics model F is defined by the following Expression (1A).

$$\begin{matrix}[ Math . 1 ] & \\ {y}_{t + 1} = F ( {y}_{t} , {a}_{t} ) & ( 1 A )\end{matrix}$$

The inverse dynamics model F⁻¹ is defined by the following Expression (1B).

$$\begin{matrix}[ Math . 2 ] & \\ {a}_{t} = {F}^{- 1} ( {y}_{t} , {y}_{t + 1} ) & ( 1 B )\end{matrix}$$

Note that t in each of the above expressions represents time. The forward dynamics model F and the inverse dynamics model F⁻¹ are achieved by using a known dynamics model or a machine learning model.

Parameters are set in advance to the forward dynamics model F and the inverse dynamics model F⁻¹ so as to satisfy the following Expressions (1) and (2).

$$\begin{matrix}[ Math . 3 ] & \\ \begin{matrix}{min}_{F} {L}_{fwd} ( F ) & = & 𝔼 [ {‖ {y}_{t + 1} - F ( {y}_{t} , {a}_{t} ) ‖}_{2} ] ;\end{matrix} & ( 1 ) \\ \begin{matrix}{min}_{{F}^{- 1}} {L}_{inv} ( {F}^{- 1} ) & = & 𝔼 [ {‖ {a}_{t} - {F}^{- 1} ( {y}_{t} , {y}_{t + 1} ) ‖}_{2} ] .\end{matrix} & ( 2 )\end{matrix}$$

In each of the above expressions, ∥ and ∥₂ each represent an L2 norm, and E represents an expected value.

In the present embodiment, the forward dynamics model F that minimizes the loss function L_{fwd} of the above Expression (1) is generated in advance. In addition, the inverse dynamics model F⁻¹ that minimizes the loss function Lᵢₙᵥ of the above Expression (2) is generated in advance. The forward dynamics model F and the inverse dynamics model F⁻¹ are used in a domain translation framework to be described later.

### (D. Domain Translation Framework)

As illustrated in FIG. 3, the domain translation framework of the present embodiment is a framework that achieves conversion from the domain X of collaborative behavior between the human and the dual arm robot to the domain Y of behavior of the dual arm robot. Hereinafter, a specific description will be given.

### (1) Domain Translation

In the present embodiment, a state transition function G for performing mapping from the state x of the behavior data to the state y of the behavior data is generated using adversarial learning. Specifically, a generator in the generative adversarial network model is generated, and the generator is used as a state transition function. By the adversarial learning, in response to input of the state x of the behavior data, a generator G generates the state y\hat{ } of pseudo behavior data according to the following expression. The generator G generates the state y\hat{ } of the behavior data that deceives a discriminator Dy in the generative adversarial network model.

$$\begin{matrix}[ Math . 4 ] & \\ \hat{y} = G ( x ) & \end{matrix}$$

On the other hand, the discriminator Dy in the generative adversarial network model attempts to distinguish whether the input behavior data is the state y\hat{ } of the behavior data generated by the generator G or the state y of the behavior data that is actual.

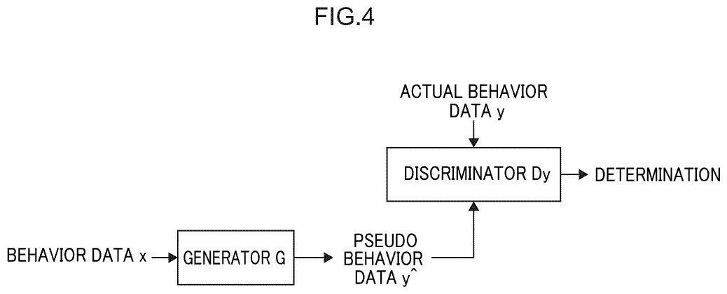

FIG. 4 explanatorily illustrates the generative adversarial network model according to the present embodiment. As illustrated in FIG. 4, in response to input of the state x of the behavior data into the generator G, the generator G outputs the state y\hat{ } of the pseudo behavior data corresponding to the state x of the behavior data. The state y\hat{ } of the behavior data is data simulating the state of the dual arm robot. The discriminator Dy determines whether or not the behavior data y\hat{ } is behavior data representing the actual state of the dual arm robot.

As illustrated in FIG. 4, in the adversarial learning, the generator G is trained to output the state y\hat{ } of the behavior data that deceives the discriminator Dy. Further, in the adversarial learning, the discriminator Dy is trained such that the state y\hat{ } of the behavior data output by the generator G can be determined to be a counterfeit.

Specifically, in the adversarial learning of the present embodiment, the generator G and the discriminator Dy in the generative adversarial network model are generated such that the following Expression (3) is satisfied.

Note that p(x) in the following expression represents a probability distribution that x appears, and p(y) represents a probability distribution that y appears.

$$\begin{matrix}[ Math . 5 ] & \\ {min}_{G} {max}_{Dy} {L}_{adv} ( G , {D}_{y} ) = {𝔼}_{y ∼ p ( y )} [ log {D}_{y} ( y ) ] + {𝔼}_{x ∼ p ( x )} [ log ( 1 - {D}_{y} ( G ( x ) ) ) ] . & ( 3 )\end{matrix}$$

Therefore, in the present embodiment, relating to the generative adversarial network model of the above Expression (3), the generator G is generated such that the loss function L_{adv}(G, Dy) is minimized and the discriminator Dy is generated such that the loss function L_{adv}(G, Dy) is maximized. In the present embodiment, in order to prevent the generator G from overfitting the demonstration data of the domain X and the random data of the domain Y, the random data of the domain X is also used as training data.

### (2) Dynamics Consistency

In the present embodiment, the generative adversarial network model is trained in consideration of the consistency of dynamics of the dual arm robot. If the generator G is generated without any restriction, the state y\hat{ } of the behavior data converted by the generator G may be inconsistent with the state transition P_{y} in the domain Y.

Therefore, in the present embodiment, the generator G is generated so as to maintain the consistency of the state transition P_{y} between a state yₜ\hat{ } at time t and a state yₜ₊₁\hat{ } at time t+1.

Specifically, the action aₜ\tilde{ } taken by the dual arm robot at time t is calculated by the inverse dynamics model F⁻¹ according to the following expression.

$$\begin{matrix}[ Math . 6 ] & \\ {\tilde{a}}_{t} = {F}^{- 1} ( {\hat{y}}_{t} , {\hat{y}}_{t + 1} ) & \end{matrix}$$

Further, the state yₜ₊₁\tilde{ } at time t+1 is calculated by the dynamics model F according to the following expression.

$$\begin{matrix}[ Math . 7 ] & \\ {\tilde{y}}_{t + 1} = {F}^{- 1} ( {\hat{y}}_{t} , {\tilde{a}}_{t} ) & \end{matrix}$$

The state yₜ₊₁\tilde{ } at time t+1 calculated by the dynamics model F and the inverse dynamics model F⁻¹ needs to match the state yₜ₊₁\hat{ } at time t+1 output from the generator G. Therefore, in the present embodiment, a loss function L_{dyn}(G) relating to the consistency of dynamics is set. The loss function L_{dyn}(G) relating to the consistency of dynamics is expressed by the following Expression (4).

$$\begin{matrix}[ Math . 8 ] & \\ {min}_{G} {L}_{dy n} ( G ) = 𝔼 [ {‖ {\tilde{y}}_{t + 1} - {\hat{y}}_{t + 1} ‖}_{1} ] & ( 4 )\end{matrix}$$

Note that ∥ and ∥₁ in the above expression each represents an L1 norm. In the present embodiment, the generator G is generated such that the loss function L_{dyn}(G) relating to the consistency of dynamics is minimized.

### (3) Partial Identity Mapping

Even if the domain translation and the consistency of dynamics are considered, there is a case where a state y^{Ri} far from the state x^{Ri} that is the actual data is output from the generator G. For example, the generator G may output a state y^{Ri} that cannot be taken by an arm of the dual arm robot.

Therefore, in the present embodiment, a loss function L_{id}(G) relating to the partial identity mapping is set. The loss function L_{id}(G) relating to the partial identity mapping is expressed by the following Expression (5).

$$\begin{matrix}[ Math . 9 ] & \\ {min}_{G} {L}_{id} ( G ) = 𝔼 [ {‖ {\hat{y}}^{Ri} - {x}_{t}^{Ri} ‖}_{2} ] , & ( 5 )\end{matrix}$$

In the present embodiment, the generator G is generated such that the loss function L_{id}(G) relating to the partial identity mapping is minimized.

### (4) Integrated Loss Function

In the present embodiment, the above loss functions are integrated, so that the following loss function L_{full} is set. The generator G and the discriminator Dy of the generative adversarial network model are trained such that the loss function L_{full} of the following Expression (6) is minimized. λ_{adv}, λ_{dyn}, and λ_{id} in the following Expression (6) are weights and are set in advance.

$$\begin{matrix}[ Math . 10 ] & \\ {L}_{full} = {λ}_{adv} {L}_{adv} ( G , Dy ) + {λ}_{dy n} {L}_{dy n} ( G ) + {λ}_{id} {L}_{id} ( G ) , & ( 6 )\end{matrix}$$

As described above, the forward dynamics model F and the inverse dynamics model F⁻¹ are trained in advance on the basis of random data. The forward dynamics model F and the inverse dynamics model F⁻¹ may be updated together when the generative adversarial network model is trained. For example, the parameters included in the forward dynamics model F and the parameters included in the inverse dynamics model F⁻¹ may be updated together when the generative adversarial network model is trained.

### (Trained-Model Generation System 1)

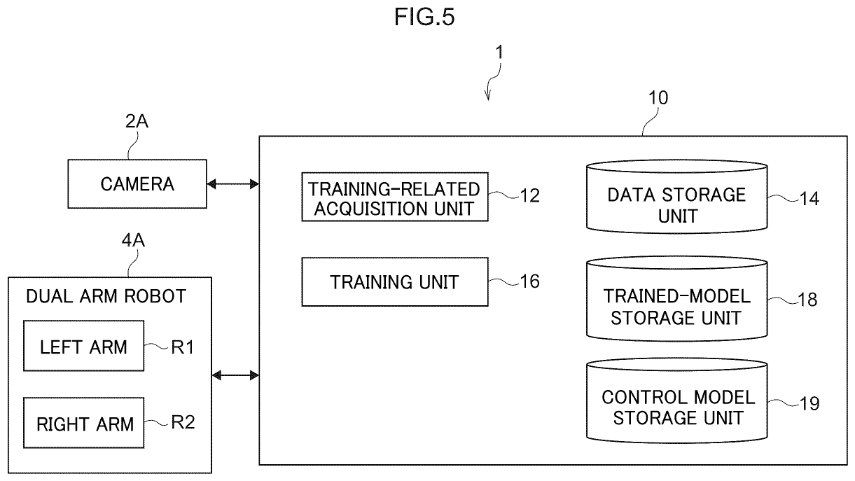

FIG. 5 is a block diagram illustrating the schematic configuration of a trained-model generation system 1 of the present embodiment. As illustrated in FIG. 5, the trained-model generation system 1 includes a camera 2A, a dual arm robot 4A, and a trained-model generation device 10. The trained-model generation device 10 according to the present embodiment generates behavior data of a dual arm robot from behavior data of a human.

The camera 2A sequentially captures images while the first arm R1 and the second arm R2 of the dual arm robot 4A to be controlled and the human H are performing behavior. For example, the camera 2A sequentially captures images during demonstration T1 and demonstration T2 as illustrated in FIG. 1. The camera 2A sequentially captures images while the first arm R1 and the second arm R2 of the dual arm robot 4A are performing random behavior. The camera 2A sequentially captures images while the human is performing random behavior. Then, the camera 2A outputs the obtained image data to the trained-model generation device 10.

The dual arm robot 4A is such a robot as illustrated in FIG. 1, and includes the first arm R1 and the second arm R2.

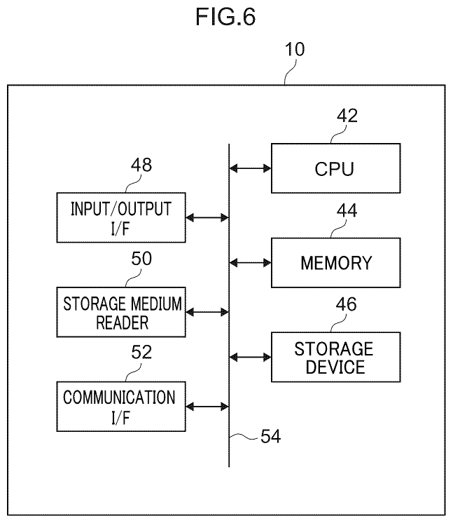

FIG. 6 is a block diagram illustrating the hardware configuration of the trained-model generation device 10 according to the present embodiment. As illustrated in FIG. 6, the trained-model generation device 10 includes a central processing unit (CPU) 42, a memory 44, a storage device 46, an input/output interface (I/F) 48, a storage medium reader 50, and a communication I/F 52. The respective components are communicably connected to each other through a bus 54.

The storage device 46 stores a trained-model generation program for performing each piece of processing to be described later. The CPU 42 is a central processing unit, and executes various programs and controls each component. That is, the CPU 42 reads such a program from the storage device 46 to execute the program using the memory 44 as a work area. The CPU 42 controls each of the above components and performs various types of arithmetic processing according to the program stored in the storage device 46.

The memory 44 includes a random access memory (RAM), and temporarily stores a program and data as a work area. The storage device 46 includes, for example, a read only memory (ROM), a hard disk drive (HDD), and a solid state drive (SSD), and stores various programs including an operating system and various pieces of data.

The input/output I/F 48 is an interface that inputs data from the camera 2A and the dual arm robot 4A and outputs data to the camera 2A and the dual arm robot 4A. Further, for example, an input device for performing various inputs, such as a keyboard or a mouse, and an output device for outputting various types of information, such as a display or a printer, may be connected. A touch panel display may be employed as an output device to function as an input device.

The storage medium reader 50 reads data stored in various storage media such as a compact disc (CD)-ROM, a digital versatile disc (DVD)-ROM, a Blu-ray disc, and a universal serial bus (USB) memory, and writes data into the storage medium, for example.

The communication I/F 52 is an interface for communicating with other devices, and for example, a standard such as Ethernet (registered trademark), FDDI, or Wi-Fi (registered trademark) is used.

Next, the functional configuration of the trained-model generation device 10 will be described. As illustrated in FIG. 5, the trained-model generation device 10 functionally includes a training-related acquisition unit 12 and a training unit 16. Further, a data storage unit 14, a trained-model storage unit 18, and a control model storage unit 19 are provided in a predetermined storage area of the trained-model generation device 10. Each functional configuration is implemented by the CPU 42 reading each program stored in the storage device 46, loading the program into the memory 44, and executing the program.

The data storage unit 14 stores image data as a result of capturing by the camera 2A. Further, the data storage unit 14 stores control data as a result of performing behavior by the dual arm robot 4A.

The trained-model storage unit 18 stores a trained generative adversarial network model generated by processing to be described later.

The control model storage unit 19 stores a control model for controlling the dual arm robot 4A.

The training-related acquisition unit 12 acquires training data. Specifically, the training data is obtained from processing image data and control data stored in the data storage unit 14, for example, and the training-related acquisition unit 12 calculates the training data to be used for causing a generative adversarial network model to be described later. The training data of the present embodiment is data including behavior data of the human H for training and behavior data of the dual arm robot 4A for training.

Specifically, the training data of the present embodiment includes demonstration data representing collaborative behavior by the first arm R1 and an arm of the human H, demonstration data representing collaborative behavior by the second arm R2 and an arm of the human H, random data representing random behavior of the dual arm robot 4A, and random data representing random behavior of the human H.

The demonstration data representing the collaborative behavior by the first arm R1 and the arm of the human H is the demonstration data {x^{R1}, x^{H}, x^{b} a^{R1}}^{|D|} of “Robot 1-Human” illustrated in FIG. 3. The demonstration data representing the collaborative behavior by the second arm R2 and the arm of the human H is the demonstration data {x^{H}, x^{R2}, x^{b}, a^{R2}}^{|D|} of “Human-Robot 2” illustrated in FIG. 3.

The random data representing the random behavior of the dual arm robot 4A and the random data representing the random behavior of the human H are the random data {x^{R1}, x^{H}, x^{b}, a^{R1}}^{|D|} of “Robot 1-Human”, the random data {x^{H}, x^{R2}, x^{b}, a^{R2}}^{|D|} of “Human-Robot 2”, and the random data {y^{R1}, y^{R2}, y^{b}, a^{R1}, a^{R2}}^{|D|} of “Robot 1-Robot 2” illustrated in FIG. 3.

The training-related acquisition unit 12 analyzes the image data and the control data stored in the data storage unit 14 to specify the respective positions, movement speeds, and others of the two-dimensional barcodes Q1 and Q2 illustrated in FIG. 1. Then, the training-related acquisition unit 12 combines the positions and movement speeds of the two-dimensional barcodes Q1 and Q2 with the control data of the dual arm robot 4A to acquire such demonstration data and random data as described above.

The training unit 16 causes the generative adversarial network model including the generator G and the discriminator Dy to perform machine learning, on the basis of the training data acquired by the training-related acquisition unit 12, thereby generating a trained generator G that outputs the behavior data y of the dual arm robot 4A in response to input of the behavior data x representing the behavior of the human H as a target.

Specifically, the training unit 16 causes the generative adversarial network model to perform machine learning such that the integrated loss function L_{full} indicated in the above expression (6) is minimized. As described above, the integrated loss function L_{full} is a function including the loss function L_{adv} relating to the generative adversarial network model and the loss function L_{dyn} relating to the consistency of dynamics, and the loss function L_{id} relating to the partial identity mapping.

The minimization of each loss function will be described below.

### (Loss Function L_{adv} Relating to Generative Adversarial Network Model)

The training unit 16, substantially, causes the generator G to train such that the loss function L_{adv} relating to the generative adversarial network model indicated in the above expression (3) is minimized, and causes the discriminator Dy to train such that the loss function L_{adv} relating to the generative adversarial network model is maximized.

### (Loss Function L_{dyn} Relating to Consistency of Dynamics)

The training unit 16, substantially, causes the generator G to train such that the loss function L_{dyn} relating to the consistency of dynamics indicated in the above expression (4) is minimized.

As described above, in the present embodiment, due to the input of the state yₜ of the dual arm robot 4A at time t and the action at of the dual arm robot 4A at time t, the forward dynamics model F that outputs the state yₜ₊₁ of the dual arm robot 4A at time t+1 is prepared in advance. Further, in the present embodiment, due to the input of the state yₜ of the dual arm robot 4A at time t and the state yₜ₊₁ of the dual arm robot 4A at time t+1, the inverse dynamics model F⁻¹ that outputs the estimated action at of the dual arm robot 4A at time t is prepared in advance.

Therefore, when causing the generative adversarial network model to perform machine learning, the training unit 16 inputs the state yₜ\hat{ } of the dual arm robot 4A at time t and the state yₜ₊₁\hat{ } of the dual arm robot 4A at time t+1 output from the generator G into the inverse dynamics model F⁻¹ to calculate the estimated action aₜ\tilde{ } of the dual arm robot 4A at time t.

Further, when causing the generative adversarial network model to perform machine learning, the training unit 16 inputs the state yₜ\hat{ } of the dual arm robot 4A output from the generator G and the action aₜ\tilde{ } calculated by the inverse dynamics model F⁻¹ into the dynamics model F, to calculate the state yₜ₊₁\tilde{ } of the dual arm robot 4A at time t+1.

Then, the training unit 16 causes the generator G to train such that a small difference is made between the state yₜ₊₁\hat{ } of the dual arm robot 4A at time t output from the generator G and the calculated state yₜ₊₁\tilde{ } of the dual arm robot 4A at time t+1.

### (Loss Function L_{id} Relating to Partial Identity Mapping)

The training unit 16, substantially, causes the generator G to train such that the loss function L_{id} relating to the partial identity mapping indicated in the above expression (5) is minimized.

Specifically, the training unit 16 generates the trained generator G by causing the generator G to train such that a small difference is made between the behavior data x of the dual arm robot 4A for training and the state y\hat{ } of the dual arm robot 4A output from the generator G.

Then, the training unit 16 stores the trained generative adversarial network model including the trained generator G and the trained discriminator Dy into the trained-model storage unit 18.

Next, the training unit 16 inputs target behavior data of the human as a target into the trained generator G to generate behavior data of the robot of the dual arm robot 4A. Here, the behavior of the human as a target corresponds to the behavior desired to be taught to the dual arm robot 4A.

The training unit 16 trains a control model for controlling the dual arm robot 4A, on the basis of the generated behavior data of the dual arm robot 4A, thereby generating a trained model for control that outputs the action a in the behavior data in response to input of the state y in the behavior data.

For example, the training unit 16 generates a trained model for control using known imitation learning. As a result, a trained model for control reflecting the measure for generating the action a from the state y can be obtained. Note that a known function or machine learning model can be adopted as the control model.

Then, the training unit 16 stores the trained model for control into the control model storage unit 19.

### (Control System 20)

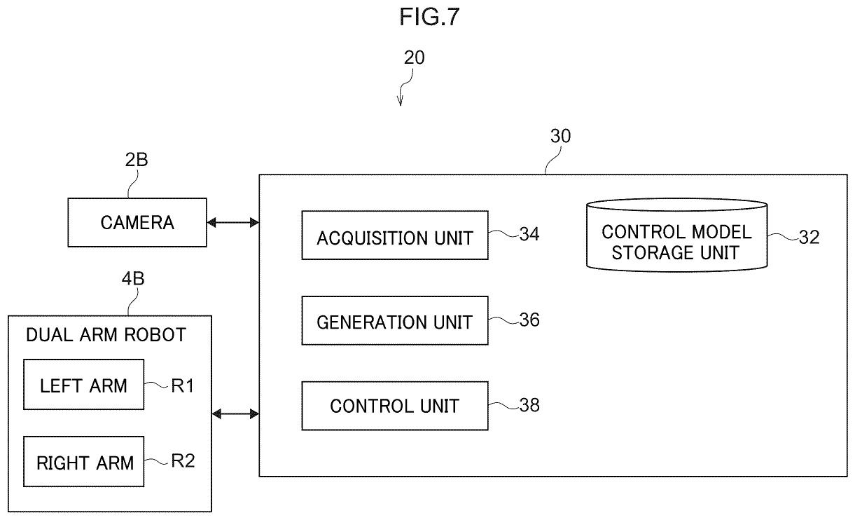

FIG. 7 is a block diagram illustrating the schematic configuration of a control system 20 of the present embodiment. As illustrated in FIG. 7, the control system 20 includes a camera 2B, a dual arm robot 4B, and a control device 30. The control device 30 according to the present embodiment controls the behavior of the dual arm robot 4B using the trained model for control generated by the trained-model generation device 10.

The camera 2B has a configuration similar to that of the camera 2A described above, and sequentially captures images while the first arm R1 and the second arm R2 of the dual arm robot 4B to be controlled are performing behavior. Then, the camera 2B outputs the obtained image data to the control device 30.

The dual arm robot 4B has a configuration similar to that of the dual arm robot 4A described above, and is such a robot as illustrated in FIG. 1.

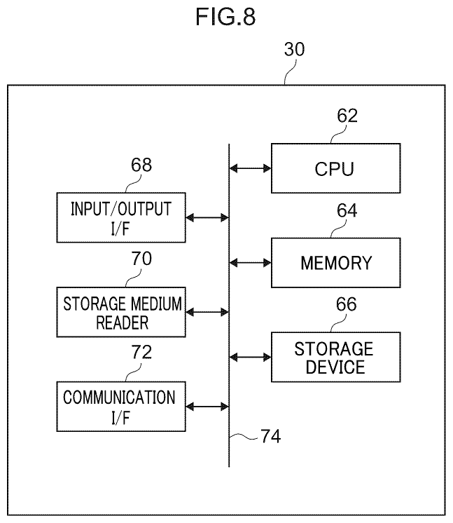

FIG. 8 is a block diagram illustrating the hardware configuration of the control device 30 according to the present embodiment. As illustrated in FIG. 8, the control device 30 includes a central processing unit (CPU) 62, a memory 64, a storage device 66, an input/output interface (I/F) 68, a storage medium reader 70, and a communication I/F 72. The respective components are communicably connected to each other through a bus 74.

The storage device 66 stores a control program for performing each piece of processing to be described later. The CPU 62 is a central processing unit, and executes various programs and controls each component. That is, the CPU 62 reads such a program from the storage device 66 to execute the program using the memory 64 as a work area. The CPU 62 controls each of the above components and performs various types of arithmetic processing according to the program stored in the storage device 66.

The memory 64 includes a random access memory (RAM), and temporarily stores a program and data as a work area. The storage device 66 includes, for example, a read only memory (ROM), a hard disk drive (HDD), and a solid state drive (SSD), and stores various programs including an operating system and various pieces of data.

The input/output I/F 68 is an interface that inputs data from the camera 2B and the dual arm robot 4B and outputs data to the camera 2B and the dual arm robot 4B. Further, for example, an input device for performing various inputs, such as a keyboard or a mouse, and an output device for outputting various types of information, such as a display or a printer, may be connected. A touch panel display may be employed as an output device to function as an input device.

The storage medium reader 70 reads data stored in various storage media such as a compact disc (CD)-ROM, a digital versatile disc (DVD)-ROM, a Blu-ray disc, and a universal serial bus (USB) memory, and writes data to the storage medium, for example.

The communication I/F 72 is an interface for communicating with other devices, and for example, a standard such as Ethernet (registered trademark), FDDI, or Wi-Fi (registered trademark) is used.

Next, the functional configuration of the control device 30 will be described. As illustrated in FIG. 7, the control device 30 functionally includes an acquisition unit 34, a generation unit 36, and a control unit 38. Further, a control model storage unit 32 is provided in a predetermined storage area of the control device 30. Each functional configuration is implemented by the CPU 62 reading each program stored in the storage device 66, loading the program into the memory 64, and executing the program.

The control model storage unit 32 stores the trained model for control generated by the trained-model generation device 10.

The acquisition unit 34 acquires the state of the dual arm robot 4B and the state of the object. Specifically, the acquisition unit 34 calculates the state (y^{R1}, y^{R2}, y^{b}) of the dual arm robot 4B and the object b on the basis of the image data captured by the camera 2B and the control data of the dual arm robot 4B.

The generation unit 36 inputs the state (y^{R1}, y^{R2}, y^{b}) acquired by the acquisition unit 34 into the trained model for control stored in the control model storage unit 32, thereby generating the action (a^{R1}, a^{R2}) of the dual arm robot 4B corresponding to the state (y^{R1}, y^{R2}, y^{b}).

The control unit 38 controls the dual arm robot 4B to take the action (a^{R1}, a^{R2}) generated by the generation unit 36. Specifically, the control unit 38 outputs a control command to the first arm R1 and the second arm R2 of the dual arm robot 4B so as to take the action (a^{R1}, a^{R2}) generated by the generation unit 36.

Next, the operation of the trained-model generation system 1 according to the present embodiment will be described.

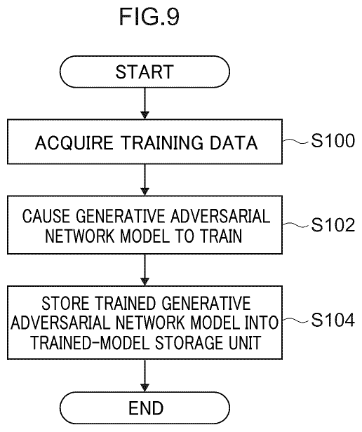

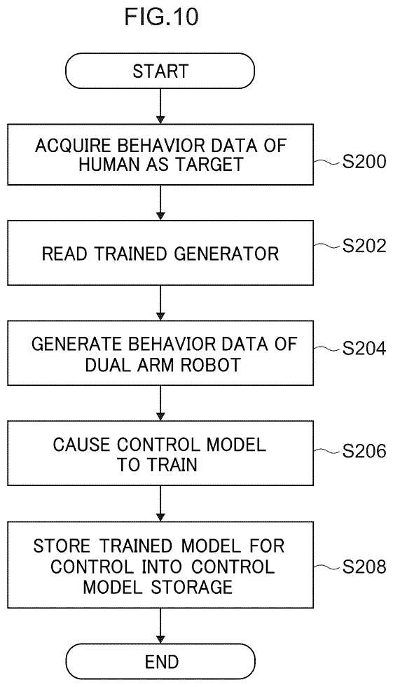

First, data relating to the behavior of the human H and the behavior of the dual arm robot 4A is collected and input to the trained-model generation device 10. The data relating to the behavior of the human H and the behavior of the dual arm robot 4A is stored into the data storage unit 14. Then, when the trained-model generation system 1 receives a predetermined instruction signal, the CPU 42 of the trained-model generation device 10 reads the trained-model generation program from the storage device 46, loads the trained-model generation program into the memory 44, and executes the trained-model generation program. As a result, the CPU 42 functions as each functional configuration of the trained-model generation device 10, and the trained-model generation processing illustrated in FIGS. 9 and 10 is performed.

In step S100, the training-related acquisition unit 12 acquires training data from the data stored in the data storage unit 14.

In step S102, the training unit 16 causes the generative adversarial network model including the generator G and the discriminator Dy to perform machine learning on the basis of the training data acquired in step S100, thereby generating the trained generator G that outputs the behavior data y of the dual arm robot 4A in response to input of the behavior data x representing the behavior of the human H as a target.

In step S104, the trained generative adversarial network model including the trained generator G and the trained discriminator Dy is stored into the trained-model storage unit 18.

Next, when the trained-model generation system 1 receives a predetermined instruction signal, the trained-model generation device 10 performs the trained-model generation processing illustrated in FIG. 10.

In step S200, the training unit 16 acquires the target behavior data representing the behavior of the human H as a target. For example, the training unit 16 acquires, as target behavior data, behavior data desired to be taught to the dual arm robot 4A in the behavior data of the human H included in the training data. Note that data different from the training data may be used as target behavior data.

In step S202, the training unit 16 reads the trained generator G from the trained-model storage unit 18.

In step S204, the training unit 16 inputs the target behavior data acquired in step S200 into the trained generator G read in step S202 to generate behavior data of the dual arm robot 4A.

In step S206, the training unit 16 causes the control model for controlling the dual arm robot 4A to train, on the basis of the behavior data of the dual arm robot 4A obtained in step S204, thereby generating a trained model for control that outputs the action a in the behavior data in response to input of the state y in the behavior data.

In step S208, the training unit 16 stores the trained model for control generated in step S206 into the control model storage unit 19.

Next, the operation of the control system 20 according to the present embodiment will be described.

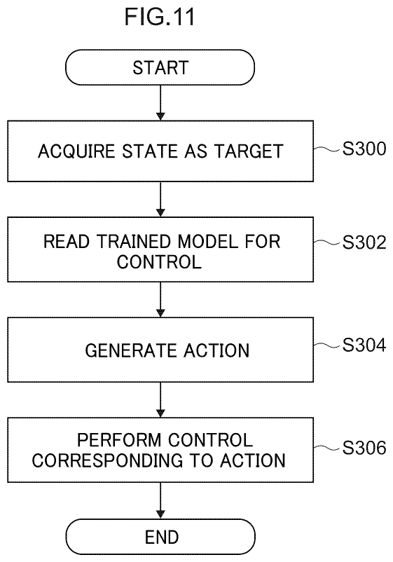

When the trained model for control generated by the trained-model generation system 1 is input to the control device 30, the trained model for control is stored into the control model storage unit 19. Then, when the control system 20 receives a predetermined instruction signal, the CPU 62 of the control device 30 reads the control program from the storage device 66, loads the control program into the memory 64, and executes the control program. As a result, the CPU62 functions as each functional configuration of the control device 30, and the control processing illustrated in FIG. 11 is performed.

In step S300, the acquisition unit 34 acquires the state (y^{R1}, y^{R2}, y^{b}) of the dual arm robot 4B and the object b from the image data captured by the camera 2B and the control data of the dual arm robot 4B.

In step S302, the generation unit 36 reads the trained model for control stored in the control model storage unit 32.

In step S304, the generation unit 36 inputs the state (y^{R1}, y^{R2}, y^{b}) acquired in step S300 into the trained model for control read in step S302, thereby generating the action (a^{R1}, a^{R2}) of the dual arm robot 4B corresponding to the state (y^{R1}, y^{R2}, y^{b}).

In step S306, the control unit 38 controls the dual arm robot 4B to take the action (a^{R1}, a^{R2}) generated in step S304.

The control processing illustrated in FIG. 11 is repeated and a control signal is repeatedly output to the dual arm robot 4A, so that the task for the object b is performed.

As described above, a trained-model generation device according to the present embodiment causes a generative adversarial network model including a generator and a discriminator to perform machine learning, on the basis of training data including behavior data of a human for training, to generate a trained generator that outputs behavior data of a control-target robot in response to input of behavior data representing behavior of the human as a target. As a result, a trained generator that can easily generate behavior data of a robot from behavior data of a human can be obtained.

The trained-model generation device according to the present embodiment generates the trained generator such that the loss function L_{full} including the loss function L_{dyn} relating to the consistency of dynamics is minimized, whereby obtained can be the trained generator that can generate behavior data in consideration of the consistency of dynamics of the dual arm robot 4A. As a result, generation of behavior data in which the dynamics of the dual arm robot 4A is ignored is prevented.

The trained-model generation device according to the present embodiment generates the trained generator such that the loss function L_{full} including the loss function L_{id} relating to the partial identity mapping is minimized, so that the trained generator that can generate behavior data adapted to the actual behavior of the dual arm robot 4A can be obtained. As a result, generation of behavior data in which the actual behavior of the dual arm robot 4A is ignored is prevented.

The trained generator is generated in consideration of the loss function L_{dyn} relating to the consistency of dynamics and the loss function L_{id} relating to the partial identity mapping, so that generation of behavior data ignoring the movable range of the dual arm robot 4A is prevented, for example.

Further, random data representing the random behavior of the dual arm robot 4A is included in the training data, so that the trained generator can be generated in consideration of how much movable range the control-target robot has.

### EXAMPLES

Next, an example will be described. In the present example, a simulation for verifying the effectiveness of the proposed LfD-HR is performed.

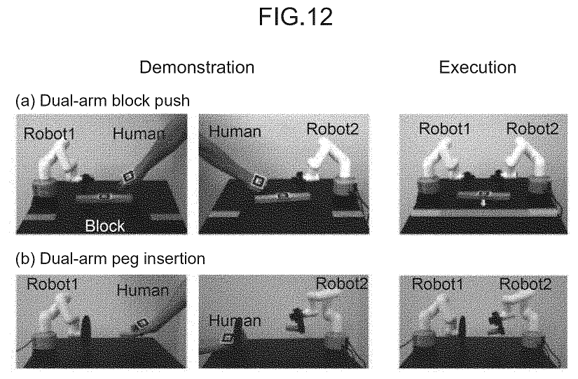

FIG. 12 explanatorily illustrates the present example. As illustrated in FIG. 12, in the present example, three simulations are performed. “Demonstration” illustrated in FIG. 12 corresponds to the demonstration T1 and T2 of FIG. 1 as described above.

Further, “Execution” illustrated in FIG. 12 corresponds to the execution phase E in FIG. 2 described above. Dual-arm block push in FIG. 12(a) is intended for collaborative behavior in which the Robot 1 and the Robot 2 push out a block.

Further, Dual-arm peg insertion in FIG. 12(b) is intended for collaborative behavior in which a peg gripped by the Robot 2 is inserted into the hole gripped by the Robot 1.

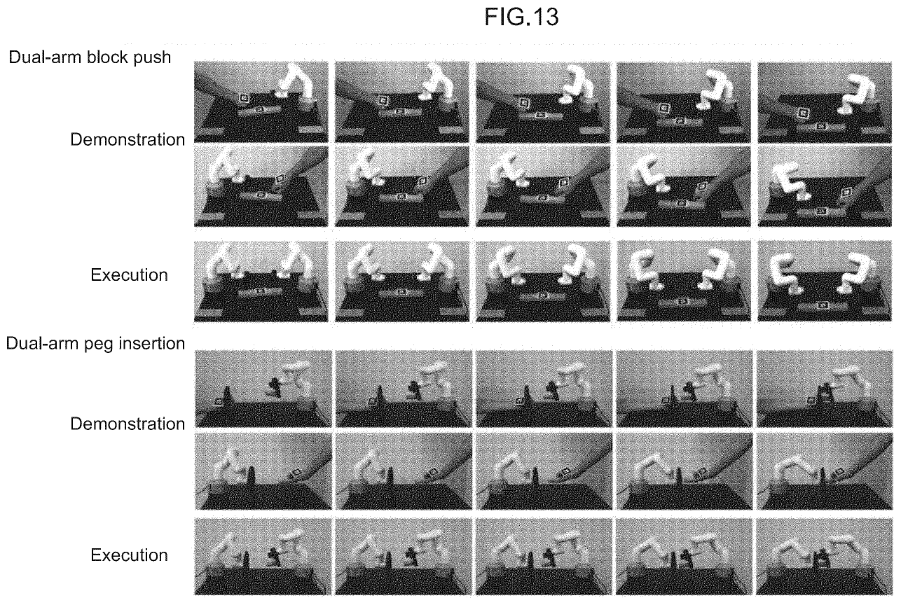

FIG. 13 illustrates the result of the present example. As illustrated in FIG. 13, according to the proposed LfD-HR, the Robot 1 and the Robot 2 perform collaborative behavior to complete a target task.

Note that in the above embodiment, the case where the control-target robot is a dual arm robot has been described as an example; however, the present disclosure is not limited thereto, and thus any robot may be a target.

For example, a robot having a single arm may be a target. As a control-target robot, for example, a robot having a plurality of fingers can also be a target. In this case, behavior data relating to the movements of the plurality of fingers is generated.

Further, various pieces of processing executed by the CPUs as described above reading software (programs) in the above embodiment may be executed by various processors different from the CPUs. Examples of the processors in this case include a programmable logic device (PLD) in which the circuit configuration can be changed after manufacturing, such as a field-programmable gate array (FPGA), a dedicated electric circuit such as an application specific integrated circuit (ASIC) that is a processor having a circuit configuration exclusively designed for executing specific processing. Each piece of processing may be executed by one of these various processors, or may be executed by a combination of two or more processors of the same type or different types (e.g., a plurality of FPGAs, or a combination of a CPU and an FPGA). More specifically, each hardware structure of these various processors is an electric circuit in which circuit elements such as semiconductor elements are combined.

Furthermore, in the above embodiment, the aspect in which each program is stored (installed) in the corresponding storage device in advance has been described, but the present disclosure is not limited thereto. Such a program may be provided in a form stored in a storage medium such as a CD-ROM, a DVD-ROM, a Blu-ray disk, or a USB memory. Alternatively, the program may be downloaded from an external device through a network.

### (Supplementary Note)

Hereinafter, aspects of the present disclosure will be described.

### (Supplementary Note 1)

A trained-model generation device including:
a training-related acquisition unit configured to acquire training data including behavior data of a human for training; and
a training unit configured to cause a generative adversarial network model including a generator and a discriminator to perform machine learning, based on the training data acquired by the training-related acquisition unit, the training unit being configured to generate a trained generator that outputs behavior data of a control-target robot in response to input of behavior data representing behavior of the human as a target.

### (Supplementary Note 2)

The trained-model generation device according to Supplementary note 1,
in which the behavior data includes a state y and an action a of the control-target robot,
a forward dynamics model F and an inverse dynamics model F⁻¹ are prepared in advance, the forward dynamics model F being to output a state yₜ₊₁ of the control-target robot at time t+1 in response to input of a state yₜ of the control-target robot at time t and an action at of the control-target robot at the time t, the inverse dynamics model F⁻¹ being to output, in response to input of the state yₜ of the control-target robot at the time t and the state yₜ₊₁ of the control-target robot at the time t+1, the action at taken by the control-target robot at the time t, and
the training unit inputs a state yₜ\hat{ } of the control-target robot at the time t and a state yₜ₊₁\hat{ } of the control-target robot at the time t+1 of the control-target robot output from the generator into the inverse dynamics model F⁻¹ to calculate an estimated action aₜ\tilde{ } of the control-target robot at the time t,
inputs the state yₜ\hat{ } and the action aₜ\tilde{ } into the forward dynamics model F to calculate a state yₜ₊₁\tilde{ } of the control-target robot at the time t+1, and
generates the trained generator by causing the generator to train such that a small difference is made between the state yₜ₊₁\hat{ } of the control-target robot at the time t output from the generator and the calculated state yₜ₊₁\tilde{ } of the control-target robot at the time t+1.

### (Supplementary Note 3)

The trained-model generation device according to Supplementary note 1 or Supplementary note 2,
in which
the training data further includes behavior data x of the control-target robot for training, and
the training unit generates the trained generator by causing the generator to train such that a small difference is made between the behavior data x of the control-target robot for training and the state y\hat{ } of the control-target robot output from the generator.

### (Supplementary Note 4)

The trained-model generation device according to any one of Supplementary note 1 to Supplementary note 3,

in which the control-target robot includes a robot including at least one or more arms.

### (Supplementary Note 5)

The trained-model generation device according to Supplementary note 4,
in which
the control-target robot includes a dual arm robot including a first arm and a second arm, and
the training data further includes
demonstration data representing collaborative behavior by the first arm and an arm of the human and
demonstration data representing collaborative behavior by the second arm and an arm of the human.

### (Supplementary Note 6)

The trained-model generation device according to any one of Supplementary note 1 to Supplementary note 3,
wherein the training data further includes
random data representing random behavior of the control-target robot and
random data representing random behavior of the human.

### (Supplementary Note 7)

The trained-model generation device according to any one of Supplementary note 1 to Supplementary note 3,
in which the training unit
inputs target behavior data representing behavior of the human as a target into the trained generator to generate behavior data of the control-target robot, and
generates a trained model for control intended for controlling the control-target robot, based on the generated behavior data of the control-target robot, the trained model for control being intended for outputting an action in the behavior data in response to input of a state in the behavior data.
   (Supplementary Note 8) A control device including:
an acquisition unit configured to acquire a state of a control-target robot;
a generation unit configured to input the state acquired by the acquisition unit into the trained model for control generated by the trained-model generation device according to Supplementary note 7 to generate an action of the control-target robot corresponding to the state; and
a control unit configured to control the control-target robot to take the action generated by the generation unit.

### (Supplementary Note 9)

A trained-model generation method to be performed by a computer, the trained-model generation method including: processing of acquiring training data including behavior data of a human for training; and
processing of causing a generative adversarial network model including a generator and a discriminator to perform machine learning, based on the training data acquired by the acquiring, to generate a trained generator that outputs behavior data of a control-target robot in response to input of behavior data representing behavior of the human as a target.

### (Supplementary Note 10)

A trained-model generation program for causing a computer to perform processing comprising: acquiring training data including behavior data of a human for training; and
causing a generative adversarial network model including a generator and a discriminator to perform machine learning, based on the training data acquired by the acquiring, to generate a trained generator that outputs behavior data of a control-target robot in response to input of behavior data representing behavior of the human as a target.

The disclosure of Japanese Patent Application No. 2023-095038 filed on Jun. 8, 2023 is incorporated herein by reference in its entirety. All documents, patent applications, and technical standards described in this specification are incorporated herein by reference to the same extent as if each individual document, patent application, and technical standard were specifically and individually indicated to be incorporated by reference.

1. A trained-model generation device comprising:
a training-related acquisition unit configured to acquire training data including behavior data of a human for training; and
a training unit configured to cause a generative adversarial network model including a generator and a discriminator to perform machine learning, based on the training data acquired by the training-related acquisition unit, the training unit being configured to generate a trained generator that outputs behavior data of a control-target robot in response to input of behavior data representing behavior of the human as a target.

2. The trained-model generation device according to claim 1,
wherein the behavior data includes a state y and an action a of the control-target robot,
a forward dynamics model F and an inverse dynamics model F⁻¹ are prepared in advance, the forward dynamics model F being to output a state yₜ₊₁ of the control-target robot at time t+1 in response to input of a state yₜ of the control-target robot at time t and an action aₜ of the control-target robot at the time t, the inverse dynamics model F⁻¹ being to output, in response to input of the state yₜ of the control-target robot at the time t and the state yₜ₊₁ of the control-target robot at the time t+1, the action aₜ taken by the control-target robot at the time t, and
the training unit inputs a state yₜ\hat{ } of the control-target robot at the time t and a state yₜ₊₁\hat{ } of the control-target robot at the time t+1 of the control-target robot output from the generator into the inverse dynamics model F⁻¹ to calculate an estimated action aₜ\tilde{ } of the control-target robot at the time t,
inputs the state yₜ\hat{ } and the action aₜ\tilde{ } into the forward dynamics model F to calculate a state yₜ₊₁\tilde{ } of the control-target robot at the time t+1, and
generates the trained generator by causing the generator to train such that a small difference is made between the state yₜ₊₁\hat{ } of the control-target robot at the time t output from the generator and the calculated state yₜ₊₁\tilde{ } of the control-target robot at the time t+1.

3. The trained-model generation device according to claim 1,
wherein
the training data further includes behavior data x of the control-target robot for training, and
the training unit generates the trained generator by causing the generator to train such that a small difference is made between the behavior data x of the control-target robot for training and the state y\hat{ } of the control-target robot output from the generator.

4. The trained-model generation device according to claim 1,
wherein the control-target robot includes a robot including at least one or more arms.

5. The trained-model generation device according to claim 4,
wherein
the control-target robot includes a dual arm robot including a first arm and a second arm, and
the training data further includes
demonstration data representing collaborative behavior by the first arm and an arm of the human and
demonstration data representing collaborative behavior by the second arm and an arm of the human.

6. The trained-model generation device according to claim 1,
wherein the training data further includes
random data representing random behavior of the control-target robot and
random data representing random behavior of the human.

7. The trained-model generation device according to claim 1,
wherein the training unit
inputs target behavior data representing behavior of the human as a target into the trained generator to generate behavior data of the control-target robot, and
generates a trained model for control intended for controlling the control-target robot, based on the generated behavior data of the control-target robot, the trained model for control being intended for outputting an action in the behavior data in response to input of a state in the behavior data.

8. A control device comprising:
an acquisition unit configured to acquire a state of a control-target robot;
a generation unit configured to input the state acquired by the acquisition unit into the trained model for control generated by the trained-model generation device according to claim 7 to generate an action of the control-target robot corresponding to the state; and
a control unit configured to control the control-target robot to take the action generated by the generation unit.

9. A trained-model generation method to be performed by a computer, the trained-model generation method comprising: processing of acquiring training data including behavior data of a human for training; and
processing of causing a generative adversarial network model including a generator and a discriminator to perform machine learning, based on the training data acquired by the acquiring, to generate a trained generator that outputs behavior data of a control-target robot in response to input of behavior data representing behavior of the human as a target.

10. A non-transitory storage medium storing a trained-model generation program that is executable by a computer to perform processing comprising: acquiring training data including behavior data of a human for training; and
causing a generative adversarial network model including a generator and a discriminator to perform machine learning, based on the training data acquired by the acquiring, to generate a trained generator that outputs behavior data of a control-target robot in response to input of behavior data representing behavior of the human as a target.
